(19) United States
(12) Patent Application Publication
(10) Pub. No.: US 2010/0061533 A1
(43) Pub. Date: Mar. 11, 2010

(54) Portable Telephony Profiles

(75) Inventor: Christopher T. Rice, San Antonio, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/206,597

(22) Filed: Sep. 8, 2008

(51) Int. Cl. H04M 3/42

(52) U.S. Cl. 379/201.03

(57) ABSTRACT

A method for providing telephony services in an IP network includes enabling a first telephony device to adopt a telephony profile of a second telephony device in response to a telephony profile event (TPE). The telephony profile defines a set of telephony services, features, and configurations associated with the end user. The TPE may be the insertion of a portable storage device (PSD) into a port of the first telephony device. The PSD may be implemented, for example, as a USB compliant memory stick. The PSD includes a storage medium embedding telephony profile information. In some embodiments, the TPE may be a request, generated by a network resource, for the telephony profile. The telephony profile request may be generated by the first telephony device itself, e.g., when an end user or administrator asserts a predetermined button, soft button, or other control element of the telephony device.

### BACKGROUND

1. Field of the Disclosure

The disclosed subject matter generally relates to communications networks and services and, more particularly, to managing telephony services for mobile users.

2. Description of the Related Art

Employees and other end users of telephones within an enterprise frequently have access to a range of telephony services. The set of telephony services defined for a particular end user constitute the telephony profile of the end user. Historically, enterprises have delegated responsibility for managing telephony services and telephony profiles to corporate administrators.

### BRIEF DESCRIPTION OF THE DRAWINGS

FIG. 1 is a block diagram of selected elements of an embodiment of a communication network;

FIG. 2 is a flow diagram of a method of implementing portable telephony profiles within a communication network such as the communication network of FIG. 1;

FIG. 3 is a flow diagram illustrating additional detail of an embodiment of the method of FIG. 2;

FIG. 4 is a block diagram of selected elements of a portable storage device suitable for use in portable telephony profile applications and methods;

FIG. 5 is a block diagram of selected elements of an embodiment of a telephony device suitable for supporting a portable telephony profile feature; and

FIG. 6 is a block diagram of selected elements of an embodiment of an alternative communication network.

### DESCRIPTION OF THE EMBODIMENT(S)

Employees and other end users within an enterprise may have access to various telephony services. Exemplary telephony services that may be supported by an enterprise's communication network include speed dialing, 4 or 5 digit extension dialing, call forwarding, call coverage, call transfer, multi party call conferencing, and others. In some cases, a set of enabled telephony services and configurations can be defined for each end user within an enterprise.

The set of telephony services defined for an end user constitutes the end user's telephony profile. Traditionally, the telephony profile of an end user has been managed by an enterprise administrator and tied to the end user's primary telephony device. When end users were out of town or otherwise away from their primary telephony device, their telephony profiles were not available to them. As a result, a traveling or a remotely located end user may, for example, not be reachable to colleagues who dial the end user's 4 or 5 digit extension. The portable telephony profile functionality disclosed herein enables end users to recreate their telephony profiles wherever they are located. When an end user is out of town or otherwise remotely located, the end user may initiate a telephony profile event (TPE) that causes a remote telephony device to adopt the telephony profile associated with the end user.

In one aspect, a disclosed method for providing telephony services to end users in an internet protocol based communication network includes enabling a first telephony device to adopt a telephony profile of a second telephony device in response to some form of a telephony profile event. The telephony profile defines a set of telephony services, features, and configurations associated with the end user or the end user's primary telephony device.

The event that initiates the profile adoption process may be the insertion of a portable storage device into a port of the first telephony device. The portable storage device may be implemented, for example, as a USB compliant memory stick. The portable storage device includes a storage medium embedding telephony profile information. The telephony profile information may define the telephony profile or indicate a networked location of the telephony profile.

In some embodiments, the event that initiates the profile adoption is a request generated by a network resource for the telephony profile. The network resource that generates the telephony profile request may be the first telephony device itself, e.g., when an end user or administrator asserts a predetermined button, soft button, or other control element of the telephony device. In these embodiments asserting the predetermined control element may cause the telephony device to display a listing of telephony profiles on a display screen of the telephony device and enable the end user to select a profile from the listing. In other embodiments, asserting the control element may cause the telephony device to initiate a search application enabling the end user to search for a desired telephony profile.

The telephony profile request may also be generated by a server or computer connected to the communication network. In these embodiments, the network may support a scheduling application that enables end users to specify a remotely located IP phone or other telephony device and a start time and end time. The scheduling application may then “push” the end user's telephony profile to the indicated telephony device and activate the profile on the device during the specified window of time.

Disclosed methods may further include enabling the second telephony device to store the telephony profile to persistent or non-volatile storage. The persistent storage to which the profile is stored may include the persistent storage of the personal storage device, persistent storage of the second telephony device itself, or persistent storage of a network attached storage resource connected to the communications network.

Adopting the telephony profile may include the steps of accessing telephony profile information indicative of the telephony profile and configuring the first telephony device with the set of telephony services defined by the telephony profile. Adopting the telephony profile may also include registering the first telephony device with the communications network.

The set of telephony services may includes a speed dialing service, a 4 or 5 digit extension dialing service, a call forwarding service, a call transfer service, a multi party call conferencing service, and other services as well. The telephony profile may also define configurations or templates for buttons, soft buttons, and other control elements of the telephony device. The telephony profile may further define enterprise directory configurations and personal directory configurations for the end user. The telephony profile may still further define Caller ID information associated with a telephony device.

In some embodiments, the communications network may include an enterprise's secure network. The enterprise network may include a premise based or hosted IP PBX. In other embodiments, the communications network may include a Voice over IP switch operating in open network based on an open and standardized network protocol such as the session initiation protocol (SIP).

In another aspect, an Internet protocol (IP) phone as disclosed herein includes a general purpose processor, a network interface coupling the IP phone to an IP network; and a voice engine. The voice engine is configured to process voice content received from the IP network and to process voice signals for transmission over the IP network. Storage media of the IP phone may include software in the form of a profile adoption module. The profile adoption module includes instructions for adopting a telephony profile of a second IP phone in response to detecting a telephony profile event.

In another aspect, a processor readable storage media as described herein includes embedded instructions for enabling an IP telephony device to adopt a telephony profile associated with an end user. The instructions may include instructions for automatically accessing telephony profile information embedded in the storage media. The profile information is indicative of the IP telephony profile. The instructions on the storage media may further include instructions for initiating a request to register the IP telephony device on an IP communication network and for configuring telephony features of the IP telephony device according to the telephony profile. The processor readable storage media may be implemented as part of a USB memory stick or other type of portable storage device that may include a storage controller for executing at least some instructions stored on the storage media.

As referenced above, in some embodiments desirable for their degree of automation, the TPE occurs when the end user inserts a portable storage device (PSD) into a suitable port or socket of the remote telephony device. The PSD may store data that fully defines the end user's telephony profile or data pointing to or otherwise identifying a networked location of the end user's telephony profile. When a properly configured PSD is inserted into the remote telephony device, code stored on the PSD executes and causes the end user's telephony profile to be uploaded from the PSD to or otherwise associated with the remote telephony device. In some embodiments, the PSD is implemented as a memory stick, flash drive, or another form of solid state drive (SSD). In these embodiments, the physical and electrical characteristics of the PSD may be compatible with the Universal Serial Bus (USB) standard or another appropriate standard.

The end user's telephony profile may be activated automatically and transparently when the remote telephony device registers itself within the enterprise's communication network. The PSD may include configuration information that facilitates the registering of the remote telephony device and the activation of the end user's telephony profile. Once the end user's telephony profile is activated on or otherwise associated with the remote telephony device, the remote telephony device mimics the end user's primary telephony device and provides the end user with the same telephony services that the end user's primary telephony device provides.

The portable telephony profile capabilities disclosed herein provide user flexibility in an area where there has been little or no flexibility historically. The disclosed functionality enables end users to manage their communications configurations while away from their primary telephony device. Traditionally, a service order or something analogous would be required to enable communications configurations on a remote telephony device that mirror those of the end user's primary telephony device. For enterprises that employ a hosted IP PBX, service orders may have to be sent to the service provider well in advance of travel every time a worker traveled to a remote location. In premises-based IP PBX enterprises, the enterprise's communications department would have to reconfigure the IP-PBX each time the end user traveled to a remote location.

Another benefit of the disclosed portable telephony profile functionality is the masking of the end user's physical location. Regardless of the physical telephony device that the end user is calling from, the Caller ID information that called parties receive would be the same, thereby reducing confusion that called parties may otherwise experience when receiving a call from an end user who is not calling from their primary telephony device. Conversely, the portable telephony profile also allows the traveling/remote end user to be reached via the same extension regardless of where they are without having to forward their calls to each location using a call forwarding feature.

The portable telephony profile concept as described herein does not require a remotely located end user to travel with or have access to a desktop or laptop computer with a soft client for mimicking the primary telephony device. In some embodiments, the remote end user can simply plug a USB enabled memory stick or other form of PSD into a remotely located IP Phone. The PSD may include one or more secure authentication keys associated with configuration information stored on the PSD. When the remotely located IP phone loads the configuration information from the PSD and performs any needed authentication, the remotely located IP phone is functionally indistinguishable from the end user's primary IP phone.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and an un-hyphenated form of the reference numeral refers to the element generically or collectively. Thus, for example, widget 12-1 refers to an instance of a set of widgets, which may be referred to collectively as widgets 12 and any one of which may be referred to generically as a widget 12.

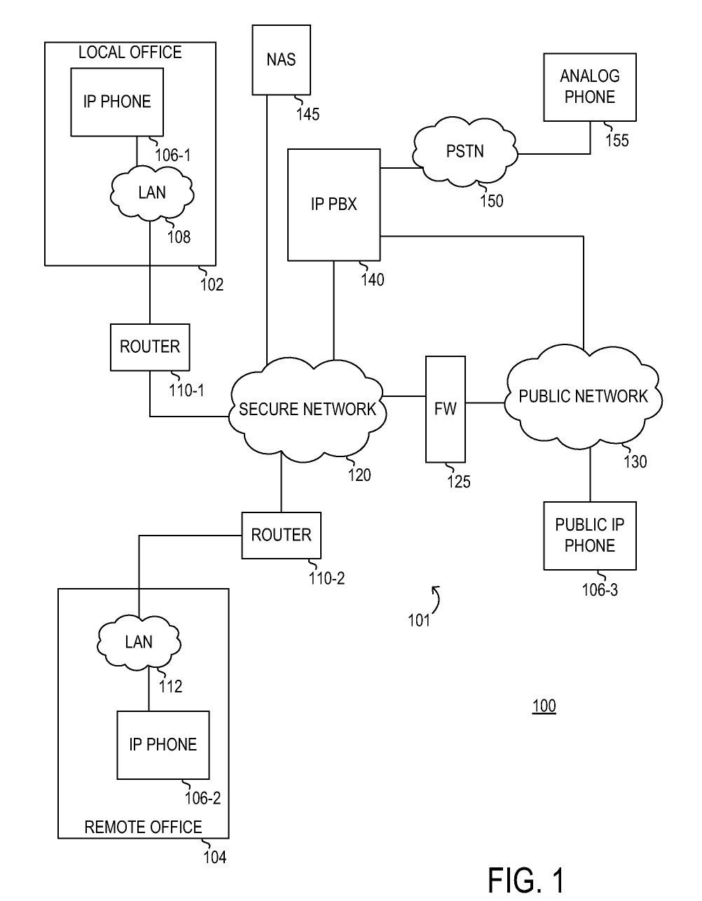

Turning to the drawings, FIG. 1 is a block diagram depicting selected elements of an embodiment of a communication network 100 suitable for implementing portable telephony profiles. As depicted in FIG. 1, communication network 100 encompasses an enterprise 101 and emphasizes a local office 102 and an out-of-town office identified as remote office 104, also referred to herein as remote office 104. Local office 102 includes a primary telephony device 106-1. Primary telephony device 106-1 is connected to a local area network (LAN) 108 of local office 102. Similarly, secondary telephony device 106-2 in remote office 104 is connected to a remote office LAN 112. Telephony devices 106 may be referred to as IP telephony devices 106 to emphasize embodiments that support IP technology. Telephony devices 106 may also be referred to as IP phones 106 to emphasize embodiments that employ hardware based IP telephony devices. Any of the telephony devices 106 depicted in FIG. 1 may include elements of commercially distributed IP phones such as any of the 7900 Series of IP phones from Cisco.

Resources connected to local office LAN 108, including primary telephony device 106-1, communicate with resources connected to LANs in other offices, including the secondary telephony device 106-2 connected to remote office LAN 112 via the enterprise's secure network 120 and associated network elements including routers 110-1 and 110-2. A firewall 125 insulates secure network 120 from a public network 130. Public network 130 may include the Internet or other freely accessible networks. A publicly available telephony device 106-3 is connected to public network 130.

The embodiment of enterprise 101 depicted in FIG. 1 includes an IP-based public branch exchange (PBX) 140 and a networked attached storage (NAS) element 145. IP PBX 140 provides an interface between the enterprise's IP-based communication network, the public IP-based communication network of which public telephony device 106-3 is a part, and the public switched telephone network (PSTN) 150 that connects analog telephone 155. IP PBX 140 may be premise-based or hosted by a service provider.

Portable telephony functionality as disclosed herein encompasses the ability to reproduce the telephony profile of primary telephony device 106-1 on secondary telephony device 106-2 or on a public telephony device 106-3. Because public telephony device 106-3 resides outside of enterprise firewall 125, public telephony device 106-3 may have to perform additional or different steps or processes to adopt the telephony profile of primary telephony device 106-1. For example, public telephony device 106-3 may need to tunnel through firewall 125 using a virtual private network (VPN) or another technique to access the applicable telephony profile. Regardless of where the remote telephony device is located, however, whether it be in a remote office within the enterprise 101 or public telephony device 106-3, the remote telephony device is enabled to adopt the telephony profile of the primary telephony device 106-1 of an end user.

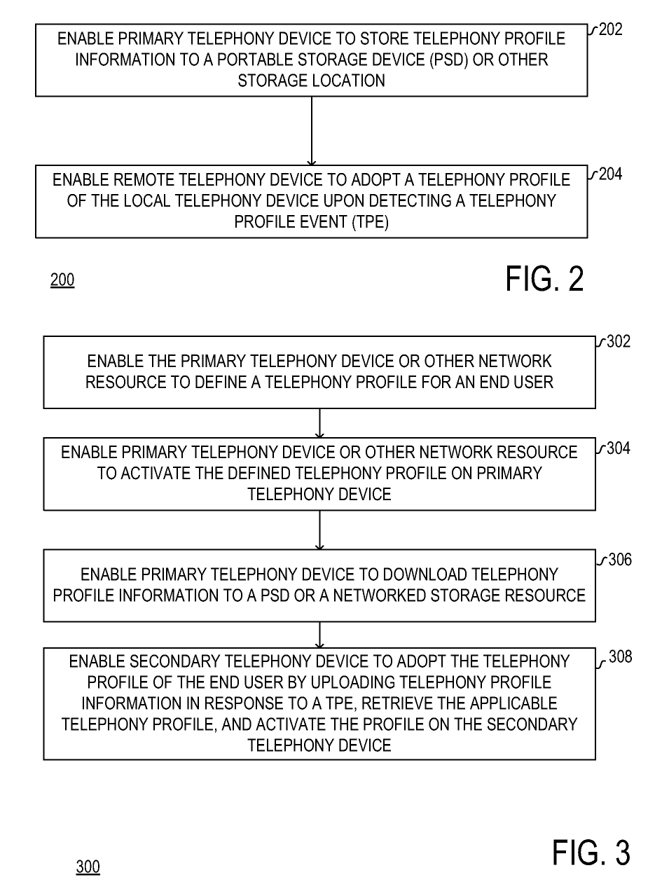

Turning now to FIG. 2, a flow diagram depicts selected elements of an embodiment of a method 200 for providing telephony services to an end user. The steps represented by the block in method 200 may be implemented as processor executable instructions that, when executed, cause a processor or a resource in communication with the processor to perform the applicable steps. The instructions may be embedded in a non-volatile computer readable medium such as a magnetic or solid state drive, a CD or DVD, a floppy disk, and so forth, or in a volatile storage medium such as a dynamic or static random access memory (RAM).

As depicted in FIG. 2, method 200 includes enabling (block 202) a primary telephony device to store telephony profile information to a storage location. The telephony profile information can be a data structure that fully defines the telephony profile or a pointer to the telephony profile data. The telephony profile information may be stored on the telephony device itself, on a PSD, or on a networked storage resource such as NAS 145. NAS 145 may operate in conjunction with a database server (not depicted).

In embodiments that employ a PSD as part of the portable telephony profile service or feature, primary telephony device 106-1 may include a port for receiving the PSD. In one embodiment, the primary telephony device 106-1 may detect that the PSD is “blank” when the PSD is inserted into the applicable port or otherwise connected or communicatively coupled to the primary telephony device 106-1. Primary telephony device 106-1 may be configured to respond to detecting the blank PSD by storing telephony profile information to the PSD.

After the telephony profile information is stored to an appropriate storage location, method 200 as depicted in FIG. 2 includes enabling (block 204) a remote telephony device such as secondary IP telephony device 106-2 to adopt a telephony profile of primary IP telephony device 106-1 when secondary IP telephony device 106-2 detects a TPE. The TPE may be an insertion of a PSD into an appropriate port of secondary IP telephony device 106-2.

In other embodiments, the TPE may include user interaction with the secondary IP telephony device or with a computer connected to the enterprise network. For example, some embodiments may elect not to employ a PSD as part of the portable telephony feature. In these embodiments, a remotely located end user may initiate a telephony profile request. The request may be scheduled in accordance and may originate from the secondary IP telephony device itself or from a computer resource that is connected to the enterprise network.

Selected elements of an exemplary implementation 300 of the portable telephony profile method 200 are depicted in the flow diagram of FIG. 3. Implementation 300 as depicted in FIG. 3 includes enabling a network resource to define (block 302) a telephony profile for an end user. Defining the telephony profile may be performed by the end user, a network administrator, or a combination of the two. The end user and/or administrator may define the telephony profile using the primary telephony device itself or via another network resource such as a desktop or laptop computer connected to the enterprise's secure network 120 or a computer connected to public network 130 that is operable to establish a session or other connection to secure network 120 via firewall 125.

The telephony profile definition process may include the end user or administrator interacting with one or more user interfaces presented via a display screen of the network resource being used to define the telephony device. When the network resource is the primary IP phone 106-1, for example, the user or administrator may define the telephony profile using interfaces presented via a display screen of primary IP phone 106-1.

The telephony profile definition process may also include the end user or administrator electing one or more telephony services and defining preferences or settings for some or all of the elected telephony services. The telephony profile definition process may encompass the definition of configuration information including, as an example, information that identifies the end user and information that identifies a location within secure network 120 where the profile information associated with the identified end user may be accessed. By storing configuration information to the PSD or another resource, some embodiments may obviate the need to store the entire telephony profile to the PSD, which may be beneficial in some applications.

Embodiment 300 as depicted in FIG. 3 further includes enabling primary IP phone 106-1 or other network resource to activate (block 304) the defined telephony profile on primary IP phone 106-1 and download (block 306) telephony profile information to one or more suitable storage locations. When the telephony profile is activated on primary IP phone 106-1, the end user has access to all of the telephony services defined for primary IP phone 106-1. The downloading of the telephony profile in block 306 may include storing the telephony profile, configuration information associated with the telephony profile, or both to a PSD, a networked storage resource, persistent storage on primary IP phone 106-1 itself, or a combination thereof.

Downloading the telephony profile information in block 306 may occur in response to a defined event. For example, embodiments that employ PSDs to facilitate portable telephony profiles may cause primary IP phone 106-1 to download telephony profile information to a PSD when the PSD is inserted into a suitable port of primary IP phone 106-1 or otherwise brought into communication with primary IP phone 106-1. In these embodiments, primary IP phone 106-1 may first determine that the PSD is a “blank” PSD, i.e., a PSD that lacks telephony profile information. Upon determining that a PSD is blank or that it contains a prior version of the telephony profile information, primary IP phone 106-1 may respond by downloading telephony profile information to the PSD.

Embodiment 300 further includes enabling a secondary telephony device such as the secondary IP phone 106-2 to adopt (block 308) the telephony profile associated with an end user or the end user's primary telephony device in response to a TPE. The TPE can be any event capable of initiating the profile adoption process. In embodiments employing PSDs, for example, the TPE may be the insertion of a PSD into secondary IP phone 106-2. In these embodiments, the user may be required to do little or nothing more than convey the PSD to secondary IP phone 106-2 and insert the PSD into a portion of secondary IP phone 106-2 to start the telephony adoption process. In other embodiments, initiating the telephony adoption process may require or permit end user or administrator interaction. In such, for example, the end user may have to interact with secondary IP phone 106-2 or another network resource to initiate the profile adoption process.

Embodiments that employ a USB memory stick or other form of PSD to transport telephony profiles to secondary telephony devices beneficially simplify the profile adoption process from the perspective of end users who are traveling or are otherwise away from their primary locations and telephony devices. In these embodiments, end users simply carry the PSD with them when they travel to any location and insert the PSD into a remotely located secondary IP phone. The end user need not know anything regarding the profile adoption and configuration process of the secondary telephony device.

In other embodiments, however, secondary telephony device 106-2 may include a soft key, button, or other control programmed to access telephony profile information of the end user from a central server and upload and activate the corresponding telephony profile. The secondary telephony device in this embodiment may enable the end user or administrator to select the appropriate profile from a list or locate the profile using a search. Upon performing any optional or required authentication of the end user via a password, PIN code, or the like, secondary IP phone 106-2 would then download and activate the appropriate telephony profile from a networked storage resource. In this embodiment, end users may be able to deactivate the adopted telephony profile by re-entering their password or PIN code or performing some other interaction with secondary IP phone 106-2 when they are finished.

Another embodiment may include a telephony profile scheduling module that enables end users to reserve a specified IP phone for a particular date and time. The scheduling module may “push” an end user's telephony profile information to the reserved secondary telephony device at the scheduled time. In this embodiment, the profile scheduling module may be further enabled to remove or otherwise uninstall or deactivate the telephony profile from secondary telephony device 106-2 at an appropriate ending time.

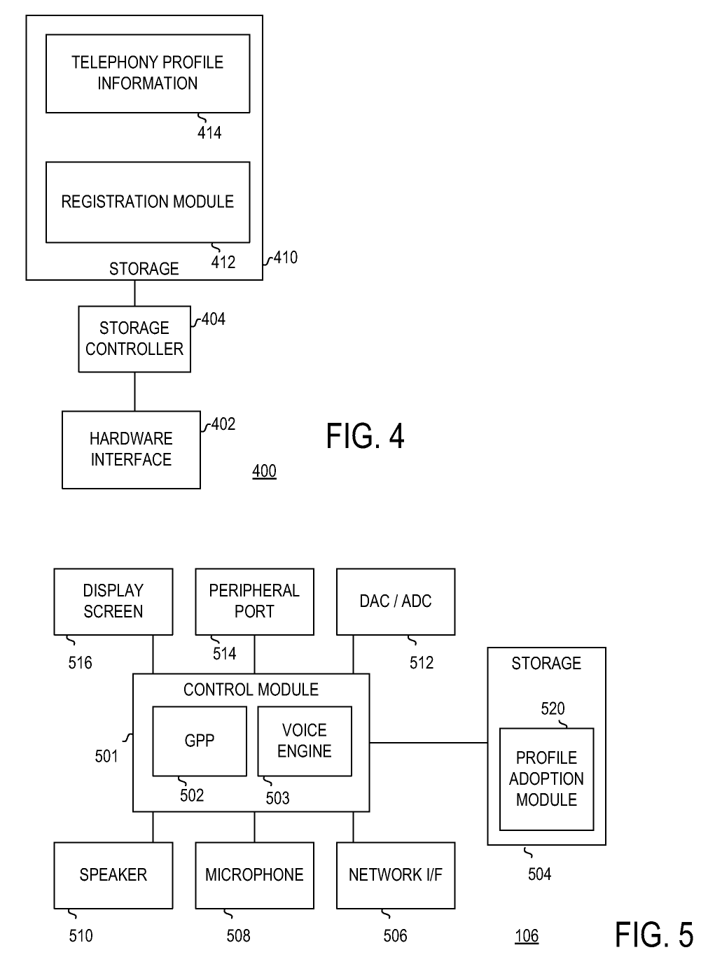

Turning now to FIG. 4, selected elements of an embodiment of a PSD 400 suitable for implementing some embodiments of the portable telephony profile functionality disclosed herein are presented. In the depicted embodiment, PSD 400 includes a hardware interface 402, a storage controller 404 operably connected to the hardware interface 402, and storage media 410, which is accessible to storage controller 404. Storage media 410, as depicted, includes embedded instructions and data structures including a registration module 412 and a data structure identified as telephony profile information 414.

In some embodiments, PSD 400 complies with the mechanical, electrical, and logical characteristics of a USB memory stick. In these embodiments, for example, the hardware interface 402 is a USB-compliant interface. Storage controller 404 is operable to execute code stored in storage 410, including the registration module 412.

In some embodiments, power to PSD 400 may be supplied via a hardware interface or peripheral port of the IP phone 106 to which the PSD is connected. In these embodiments, connecting PSD 400 to an IP phone 106 may be analogous to performing a power up or power reset. PSD 400 may respond to such a reset by executing code from a predetermined location in storage 410. In some embodiments, PSD 400 is configured to execute registration module 412 when the PSD is plugged into a suitable connector or port of an IP phone 106.

Registration module 412 may include an authentication routine presenting the user or administrator with a password, PIN, or other type of authentication sequence. Registration module 412 may further include self-executing code that automatically initiates a registration process when PSD 400 is attached to an IP phone 106. In the context of communication network 100 as depicted in FIG. 1, the registration process, as suggested by its name, registers an IP phone 106 with IP PBX 140 or another form of Voice over IP switch. Telephony profile information 414 may include information identifying the end user and the registration process may include accessing such information.

When an IP phone 106 is registered, registration module 412 may then cause the telephony device to adopt or assist the telephony device with adopting a telephony profile defined or otherwise indicated by telephony profile information 414. In some embodiments, telephony profile information 414 may include all of the data necessary to define the telephony profile while, in other embodiments, the telephony profile information 414 may include information indicative of a network location where the entire telephony profile may be accessed.

In a fully automated and user friendly implementation, the end user simply inserts PSD 400 into a peripheral port of the secondary telephony device 106-2 and, if prompted to do so, responds to a password, PIN code, or other form of authentication sequence. PSD 400 will register secondary telephony device 106-2 under the end user's name, upload the end user's telephony profile from the PSD itself or download the telephony profile from a networked storage location, and activate the profile. In this manner, the end user is required to do little if anything and needs to know little if anything about secondary telephony device 106-2, the location of telephony profile information 414, and the like.

Referring to FIG. 5, selected elements of an embodiment of a telephony device 106 are depicted. In the depicted embodiment, telephony device 106 is a hardware-based IP phone. A control module 501 of telephony device 106 includes a general purpose processor (GPP) 502 and a voice engine 503. GPP 502 is suitable for handling application messages while voice engine 503 is responsible for processing the voice content exchanged between the end user and another party. Voice engine 503 converts packet-based digital information into voice quality audio and vice versa. Voice engine 503 may support an “open” or otherwise standardized protocol suitable for distributing audio and/or multimedia content over an IP based network. An exemplary protocol that voice engine 503 may support is the Real-Time Transport Protocol (RTP) defined in RFC 3550 of the Internet Engineering Task Force (IETF). Control module 501 may be implemented as a single chip that integrates GPP 502 and voice engine 503. Other embodiments, however, may employ distinct chips for each function. Voice engine 503 may include, as an example, a digital signal processor (DSP) or other circuit or device suitable for processing audio content.

Control module 501 is communicatively coupled to various elements of telephony device 106 including storage media 504, network interface 506, a microphone 508, a speaker 510, and digital to analog (DAC) and analog to digital (ADC) converters represented by DAC/ADC 512. Telephony device 106 as shown further includes a peripheral port 514 and a display screen 516. Network interface 506 is a wired or wireless interface that enables telephony device 106 to receive digital and packet based audio content from and deliver digital, packet-based audio content to an IP network. As indicated above, voice engine 503 may comply with RTP and, in such embodiments, network interface 506 is operable to support an RTP protocol stack.

DACs and ADCs 512 facilitate conversion between analog content (voice) and digital content that is suitable for transmission over a digital network. Microphone 508, speaker 510, display screen 516, and keypad 517 are user interaction resources that enable the end user to communicate audio information via communication network 100.

Storage media 504 as shown includes a profile adoption module 520. Profile adoption module 520 may be implemented as processor executable instructions that are embedded in processor readable media such as storage media 504. Profile adoption module 520 may include instructions to detect a TPE and respond to the TPE by adopting the telephony profile of a different telephony device, such as the primary telephony device 106-1 of an end user who initiated the TPE or on whose behalf the TPE was initiated.

Portable telephony profiles be can be initiated using various techniques including techniques that include the use of a PSD and techniques that do not. In some embodiments, secondary IP phone 106-2 includes a port for receiving a PSD. Secondary IP phone 106-2 may be further configured to respond to detecting the insertion of a PSD by determining that the PSD is not a blank PSD and attempting to access and adopt a telephony profile using information stored on the PSD. In some embodiments, the telephony profile information stored on the PSD may include all of the telephony profile information needed for IP phone 106-2 to configure itself upon registering with the enterprise network. In other embodiments, the telephony profile information may be just sufficient to inform IP phone 106-2 where to retrieve or otherwise access data that defines the telephony profile.

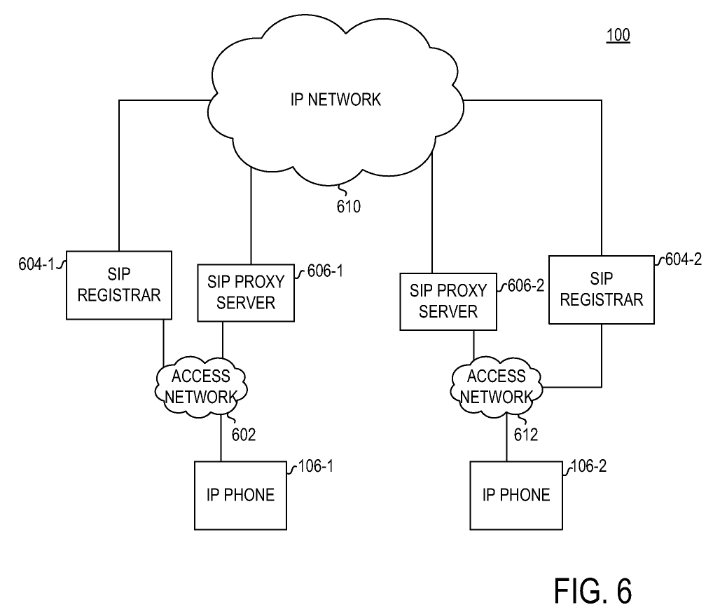

Turning to FIG. 6, a different embodiment of communication network 100 than the communication network 100 depicted in FIG. 1 is illustrated to emphasize the applicability of the portable telephony profiles to a variety of applications and environments. The embodiment of communication network 100 as depicted in FIG. 6 is exemplary of an open-standard IP telephony network. Communication network 100 as depicted in FIG. 6 may support voice communication in compliance with the Session Initiation Protocol (SIP) or another appropriate standard.

As depicted in FIG. 6, communication network 100 includes a primary IP phone 106-1 and a secondary IP phone 106-2, which may be remotely located with respect to primary IP phone 106-1. An access network 602 includes a physical media such as twisted pair, fiber optic cable, and so forth. In the embodiment depicted in FIG. 6, access network 602 connects IP phone 106-1 with a primary SIP registrar 604-1 and a primary SIP proxy server 606-1. Similarly, secondary IP phone 106-2 is connected via an access network 612 to a secondary SIP registrar 604-2 and a secondary SIP proxy server 606-2. The SIP registrars 604 handle registration requests from IP phones 106 while proxy servers 606 handle session requests as is known to those versed in SIP concepts.

A telephony profile of IP phone 106 may be stored locally, e.g., on IP phone 106 itself, or on a registrar 604 or proxy server 606. In some embodiments, end users of an IP phone 106 within communication network 100 as shown in FIG. 6 may not have access to the range of telephony services that an enterprise end user may have, but the end user in FIG. 6 may still define various configuration parameters and settings for the user's primary telephony device 106-1. When the end user then leaves home or another location where primary IP phone 106-1 is located, the end user may experience confusion or frustration because of an inability to access a familiar telephony profile similar to the experience of end users described in the network depicted in FIG. 1.

The portable telephony profile process described above with respect to the communication network 100 of FIG. 1 may be suitable for use in the context of the communication network 100 of FIG. 6. For example, the end user may connect a blank PSD to primary IP phone 106-1 and thereby store the user's telephony profile to the PSD. When the end user is later located away from primary IP phone 106-1, the user may plug the PSD into secondary IP phone 106-2.

Secondary IP phone 106-2 may be configured to respond to detecting the PSD being plugged in by retrieving the end user's telephony profile from the PSD, registering secondary IP phone 106-2 with SIP registrar 604-2, and activating the telephony profile stored on the PSD. In some implementations of communication network 100 as depicted in FIG. 6, it may not be possible or practicable to store the end user's telephony profile on a networked resource and, therefore, it may be preferable to store the telephony profile itself on the PSD and use the PSD exclusively to define and install the profile.

Using this technique, an end user that lives portions of the year in a primary location and other portions of the year in a secondary location may forego the potentially time consuming process of requesting the telephone company to deactivate the primary telephone and activate the secondary telephone each time the user changes residences. In addition, the end user need not maintain two phone numbers and those who communicate with the end user benefit by being able to communicate via a single phone number without regard to the user's location.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of providing telephony services to an end user in an internet protocol based communication network, the method comprising enabling a first telephony device to adopt a telephony profile of a second telephony device in response to a telephony profile event (TPE), wherein the telephony profile defines a set of telephony services associated with the end user.

2. The method of claim 1, wherein the TPE comprises an insertion of a portable storage device (PSD) into a port of the first telephony device.

3. The method of claim 2, wherein the PSD comprises a universal serial bus (USB) compliant PSD.

4. The method of claim 2, wherein the PSD includes a storage medium embedding telephony profile information, wherein the telephony profile information defines the telephony profile or indicates a networked location of the telephony profile.

5. The method of claim 1, wherein the TPE comprises a network resource generating a request for the telephony profile.

6. The method of claim 5, wherein the network resource is selected from the group of network resources consisting of the first telephony device and a computer connected to the communication network.

7. The method of claim 1, further comprising enabling the second telephony device to store the telephony profile to persistent storage, wherein the persistent storage is selected from a group consisting of the persistent storage of the PSD, persistent storage of the second telephony device, and persistent storage of a network attached storage resource connected to the communications network.

8. The method of claim 1, wherein adopting the telephony profile comprises accessing telephony profile information indicative of the telephony profile and configuring the first telephony device with the set of telephony services defined by the telephony profile.

9. The method of claim 1, wherein adopting the telephony profile further comprises registering the first telephony device with the communications network.

10. The method of claim 1, wherein the set of telephony services includes a speed dialing service.

11. The method of claim 1, wherein the set of telephony services includes a 4 or 5 digit extension dialing service.

12. The method of claim 1, wherein the set of telephony services includes a call forwarding service.

13. The method of claim 1, wherein the set of telephony services includes a call transfer service.

14. The method of claim 1, wherein the set of telephony services includes a multi party call conferencing service.

15. The method of claim 1, wherein the telephony profile defines templates for buttons of the telephony device.

16. The method of claim 1, wherein the telephony profile defines an enterprise directory configuration and a personal directory configuration for the end user.

17. The method of claim 1, wherein the telephony profile defines Caller ID information associated with a telephony device.

18. The method of claim 1, wherein the communications network comprises an enterprise network and wherein the enterprise network includes a Voice over IP switch.

19. The method of claim 18, wherein the Voice over IP switch is a network hosted IP PBX.

20. The method of claim 18, wherein the Voice over IP switch is a premised based IP PBX.

21. A Internet protocol (IP) phone, comprising:
a general purpose processor;
a network interface coupling the IP phone to an IP network; and
a voice engine configured to process voice content received from the IP network and to process voice signals for transmission over the IP network; and
storage media accessible to the general purpose processor, the storage media embedding a profile adoption module comprising a set of executable instructions including instructions for adopting a telephony profile of a second IP phone in response to detecting a telephony profile event (TPE).

22. The IP phone of claim 21, wherein the TPE comprises an insertion of a portable storage device (PSD) into a peripheral port of the IP phone.

23. The IP phone of claim 22, wherein the PSD comprises a USB compliant memory stick.

24. The IP phone of claim 22, wherein the PSD stores telephony profile information indicative of a telephony profile of the second IP phone.

25. The IP phone of claim 21, wherein the TPE comprises asserting a control of the second IP phone and selecting the telephony profile from a listing of telephony profiles presented via a display screen of the IP phone.

26. The IP phone of claim 21, wherein the TPE comprises detecting the telephony profile being pushed to the IP phone from a network resource.

27. The IP phone of claim 21, wherein the network resource is configured to push the telephony profile to the IP phone according to a user defined request indicating an identity of the IP phone, an identity of an end user, and schedule information defining an interval of time during which the telephony profile is to be activate on the IP phone.

28. A processor readable storage media including embedded instructions for enabling an IP telephony device to adopt a telephony profile associated with an end user, the instructions comprising instructions for automatically:
accessing telephony profile information embedded in the storage media and indicative of the IP telephony profile;
initiating a request to register the IP telephony device on an IP communication network; and
configuring telephony features of the IP telephony device according to the telephony profile.

29. The storage media of claim 28, wherein the processor readable storage media comprises a portion of a portable storage device (PSD).

30. The storage media of claim 28, wherein the PSD includes a storage controller for executing at least some instructions stored on the storage media.

31. The storage media of claim 28, wherein the PSD comprises a USB compliant memory stick.
